(19) United States
(12) Patent Application Publication
(10) Pub. No.: US 2002/0010936 A1
(43) Pub. Date: Jan. 24, 2002

(54) Digital broadcasting

(76) Inventor: John Adam, Farnham (GB)

Correspondence Address: William S. Frommer, Esq., FROMMER LAWRENCE & HAUG LLP, 745 Fifth Avenue, New York, NY, 10151, US

(21) Appl. No.: 09/825,727

(22) Filed: Apr. 4, 2001

(30) Foreign Application Priority Data
Jun. 4, 2000 (GB) 0008529.0

(51) Int. Cl. H04N 7/173

(52) U.S. Cl. 725/91

(57) ABSTRACT

A digital broadcasting arrangement comprises one or more content-originating client systems by which digital content for broadcast is originated; and a broadcast server system operable to receive digital content from the client systems and to broadcast that digital content for reception by end-users; in which: the server system is operable to assign to each client system an access permission defining at least a time period and a digital data bandwidth available within that time period; and each client system is operable to define digital content for broadcast during the time period defined by the access permission assigned to that client system and scheduling control data defining the manner in which the digital content is to be broadcast during that time period.

### BACKGROUND OF THE INVENTION

1. Field of the Invention

This invention relates to digital broadcasting.

2. Description of the Prior Art

Digital broadcasting encompasses video, audio, data and other information broadcast by digital means. In the United Kingdom, television services are broadcast using the so-called DVB standard, and digital audio broadcasting is also growing in popularity.

These techniques rely on packaging up data representing video signals, audio signals, electronic programme guides and the like into a packetised form for transmission. In the DVB standard so-called transport stream packets are 188 bytes long and can carry a digital payload of up to 184 bytes.

However, by the stage is reached where the data is being packetised, the packetising and transmission techniques are independent of the nature of the data, that is to say the nature of signal represented by the data. So, it has long been recognised that the system may transmit other types of data as well, and indeed this facility was designed into the DVB standard.

Transmitting data channels as part of the DVB signal allows a much greater data bandwidth than previous arrangements such as teletext and the radio data system (RDS) where data was buried in an analogue broadcast signal. Indeed, a bandwidth in excess of 2 Mbits/second is readily available, which is much higher than even ISDN or PSTN modem connections. Accordingly, this opens the way for entirely new types of services to be provided to the end-user. these could enhance the existing television or radio channels or could be revenue-earning ventures in their own right. Some examples are:

information services including news, weather, traffic news, programme guides

enhanced television services such as interactive game shows, audience-targeted advertisements

commercial services such as home shopping, banking, gambling

general data services such as software downloading, computer games, internet access

A force driving the development of these ancillary services is that the digital broadcast market is becoming more competitive, with the increased number of channels making it more difficult for the broadcaster to attract the audience's attention. It has been estimated (DataMonitor July 1998) that the world-wide market in data-to-the-home services was worth less than US$20m in 1997, but could be worth US$6.7bn by the year 2002.

In practical terms, the data associated with DVB television services is carried as part of the DVB transport stream as described above. The data handling protocol often used is the so-called DSM-CC (digital storage media—command and control) protocol, an ISO-IEC standard adopted by the DVB consortium. So, DSM-CC may be considered a core technology for DVB data broadcasting. Reference is made to the DVB Broadcasting Reference document TS/EN 301 192.

The DVB DSM-CC protocol allows for a number of so-called delivery profiles.

data piping—a simple, asynchronous end-to-end delivery of data

data streaming—a “streaming oriented” end-to-end delivery of synchronous or asynchronous data

multiprotocol encapsulation—a delivery of other communication protocols via the DVB transport stream, such as TCP/IP

data carousels/object carousels—a periodic and/or cyclic delivery of data modules, similar in some ways to previous teletext services

In previously proposed broadcasting arrangements, a content originator supplies content (A/V, data or other) to a broadcaster who then schedules it for transmission in amongst other programmes or services provided by that broadcaster.

### SUMMARY OF THE INVENTION

This invention provides a digital broadcasting arrangement comprising:

one or more content-originating client systems by which digital content for broadcast is originated; and

a broadcast server system operable to receive digital content from the client systems and to broadcast that digital content for reception by end-users;

in which:

the server system is operable to assign to each client system an access permission defining at least a time period and a digital data bandwidth available within that time period; and

each client system is operable to define digital content for broadcast during the time period defined by the access permission assigned to that client system and scheduling control data defining the manner in which the digital content is to be broadcast during that time period.

The invention builds on previous broadcast arrangements, by recognising that those arrangements arguably place too much control in the hands of the company actually delivering the broadcast to the end-user. Instead, in the present invention control over matters such as scheduling is placed with the client systems, which may (preferably) be operated by entities independent from the company running the broadcast server.

One way in which this could have been achieved would be simply to make the broadcast server a “dumb” store and forward arrangement. However, while that might be a possible solution in the field of linear programme delivery (e.g. the broadcast of a feature film), it is not a good solution in the field of data services where data delivery can be in a non-linear manner or even based on a carousel model where data items are repeated, some (such as indices) more frequently than others.

Preferably the content is data content for broadcast as a data (rather than a traditional A/V) service. Here, the invention is particularly useful as it recognises that the scheduling requirements of data and traditional A/V services can be quite different.

The invention is suited to various types of broadcast environment including DVB, other digital formats, terrestrial digital, satellite digital, cable digital, internet broadcasting and the like.

Further aspects and features of the invention are defined in the appended claims.

### BRIEF DESCRIPTION OF THE DRAWINGS

The above and other objects, features and advantages of the invention will be apparent from the following detailed description of illustrative embodiments which is to be read in connection with the accompanying drawings, in which:

FIG. 1 is a schematic diagram of a digital broadcasting arrangement according to an embodiment of the present invention;

FIG. 2 schematically illustrates a data interaction within the arrangement of FIG. 1;

FIG. 3 schematically illustrates an access permission;

FIG. 4 schematically illustrates a carousel type of data delivery;

FIG. 5 schematically illustrates a service delivery timeline;

FIG. 6 schematically illustrates a service delivery hierarchy planning tool; and

FIG. 7 schematically illustrates the arrangement of FIG. 1 operating in a live service feed mode.

### DESCRIPTION OF THE PREFERRED EMBODIMENTS

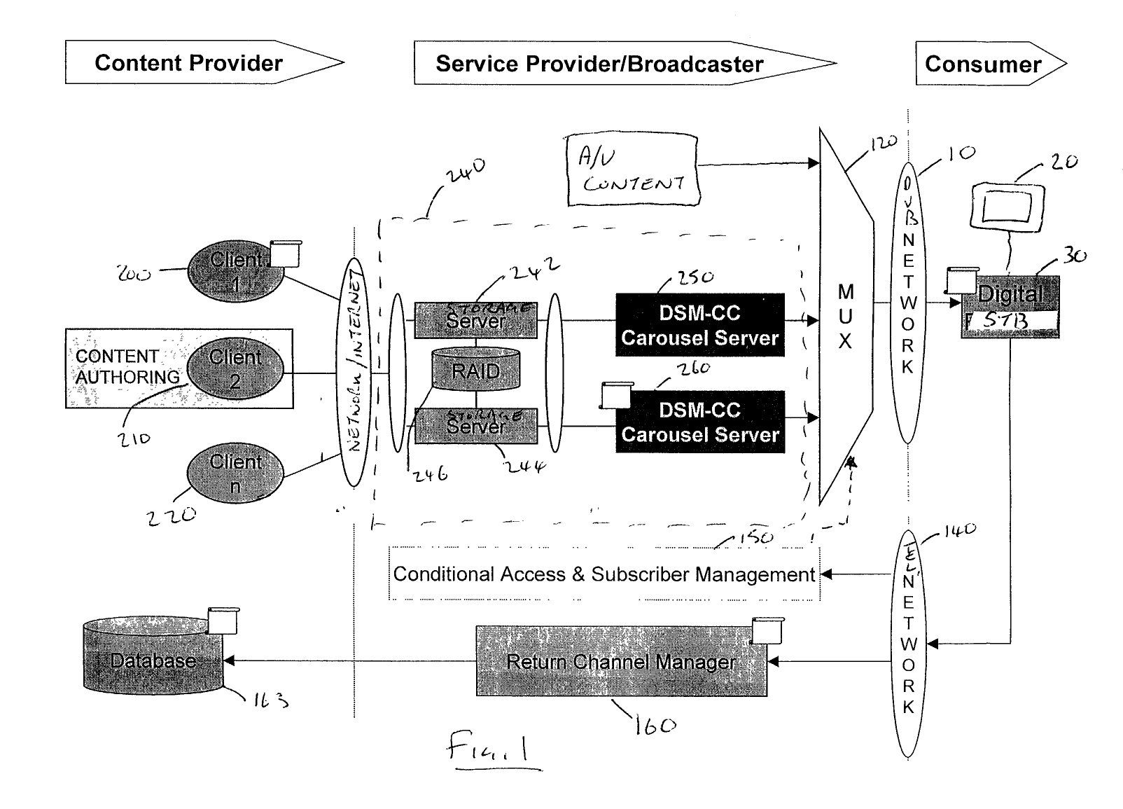

FIG. 1 of the accompanying drawings schematically illustrates a digital broadcasting arrangement, relating to the broadcast of both “conventional” audio/video (A/V) programme content and also digital data content.

In FIG. 1, the content is broadcast by a DVB broadcast network (e.g. a cable, terrestrial or satellite network) 10 to a plurality of end-users each having a television set 20 and a so-called set top box (STB) 30. The broadcast content is decoded from the DVB stream by the STB 30 and then displayed on the television set 20. In the case of interactive content, the user may issue control commands by using, for example, an infra red remote commander (not shown) or a keyboard (not shown).

A/V programme content (sourced internally by the broadcaster or externally by a third party provider) is encoded according to the MPEG-2 standard and passed to a multiplexer 120. The multiplexer 120 also receives data content (to be described below) and conditional access (e.g. “pay TV”) information from a conditional access and subscriber management unit 150. The multiplexer operates to multiplex all of this into a DVB data stream using conventional DVB techniques (here, reference is made to standard textbooks on MPEG-2 such as “Digital Television”, H Benoit, 1997, ISBN 0 340 69190 5). The DVB data stream is broadcast over the DVB network 10 and decoded at the STB 30, again by conventional techniques.

A telephone or similar reverse connection from the STB 30, via a telecommunications network 140 such as a public utility network, allows subscriber management information to be obtained and supplied to the conditional access and subscriber management unit 150—for example, including requests for access to pay TV programming. The reverse connection also allows billing to be made to each subscriber, in respect of programme content received or other transactions (e.g. home shopping) by a return channel management unit 160.

On the data content side, FIG. 1 shows a number of content-originating “client systems” 200, 210, 220 connected via a data connection network 230 such as the internet, a dial-up modem or ISDN connection, a dedicated data transfer channel or the like, to a broadcast “server system” 240.

The techniques to be described below relate mainly to data content origination (data content being, for example, the types of content described in the introduction to this application) but could relate instead to the origination of conventional A/V content or other types of content.

The output of the server system 240 is connected to the multiplexer 120 described above, and from there to the DVB network for broadcast to the end-user. These may be operated by the same entity which operates the server system 240 or by an independent broadcast channel provider.

The server system comprises two storage servers 242, 244 sharing a common fault-tolerant RAID disk array 246. Two storage servers are used to provide redundancy in case of a fault developing during a broadcast. The storage servers control the storage of incoming programme content into the RAID array 246 and the subsequent reading out of the data from the RAID array for broadcast. In controlling the reading out of the data they make use of scheduling information received from the client systems, defining which data is to be read out and broadcast at what time. The data outputs of the storage servers are passed to two respective DSM-CC carousel server units 250, 260 such as Sony (RTM) Mediacaster (TM) units, which format the data into the DSM-CC carousels or other appropriate format for broadcast.

The client systems 200 . . . 220 are operable to originate content for broadcast and associated scheduling information to control the time and nature of the broadcast of that content. Each client system comprises a computer workstation having a data connection and running appropriate software to carry out the functions described below.

A database 165 may be provided to allow return channel information such as viewing figures to be made accessible to the client system users.

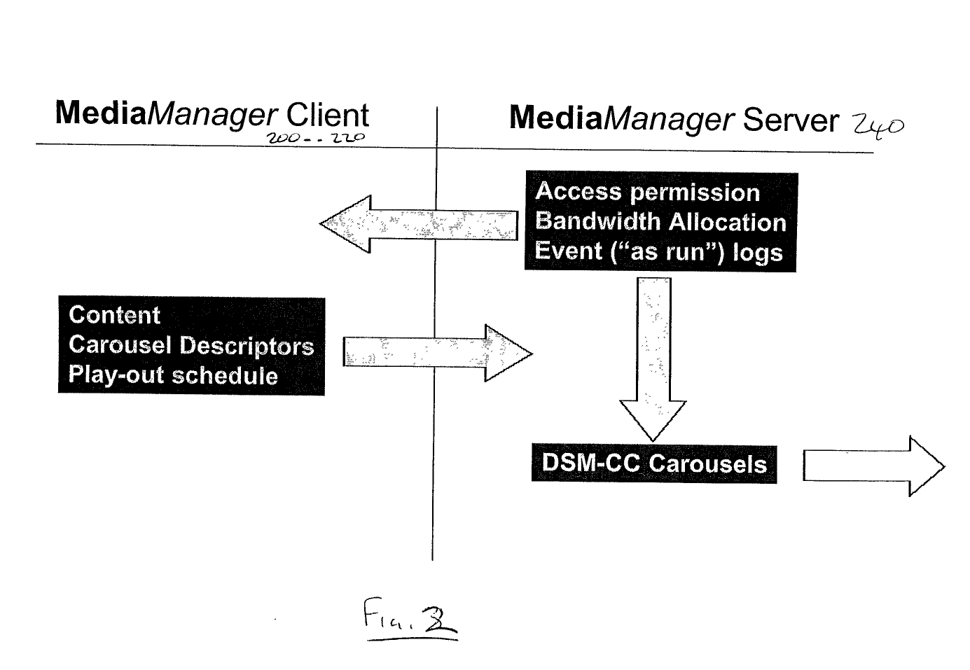

The interaction of the client systems 200 . . . 220 with the server system 240 is illustrated schematically in FIG. 2.

Referring to FIG. 2, after an appropriate commercial relationship has been established between the corporate entity operating a client system and the corporate entity operating the server system, the server system 240 first issues an “access permission” to the client system. The access permissions issued by the server system 240 are also stored by the storage servers 242, 244 for later use (see below).

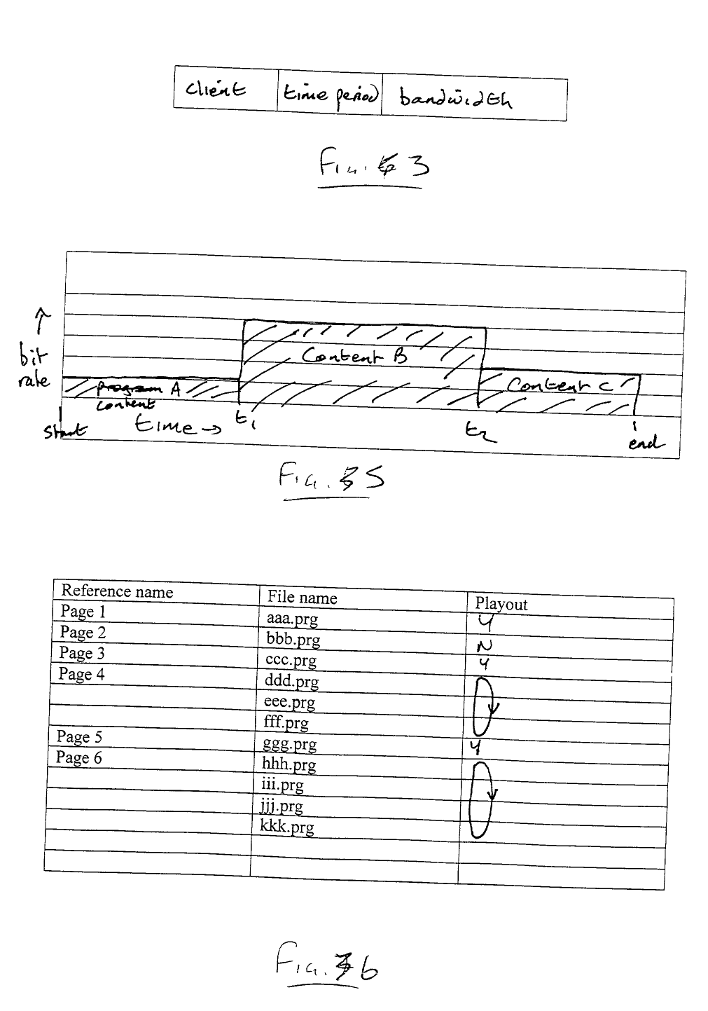

An example, in simplified form, of an access permission is illustrated schematically in FIG. 3. The access permission basically defines three things: the name (or logical identifier) of the client system, a time period for broadcast and a data bandwidth for the client system's use during that time period. The bandwidth may be defined as a constant bandwidth for the duration of the broadcast period or may be defined to vary—e.g. step up and down—during that period. It would normally be the case that the entity responsible for the client system would be expected to pay the entity operating the server system in dependence on the length of time and the bandwidth of the access permission.

Returning to FIG. 2, the client system provides the following information back to the server system:

user verification and authorisation data such as a password previously issued by the server system

data content for broadcast

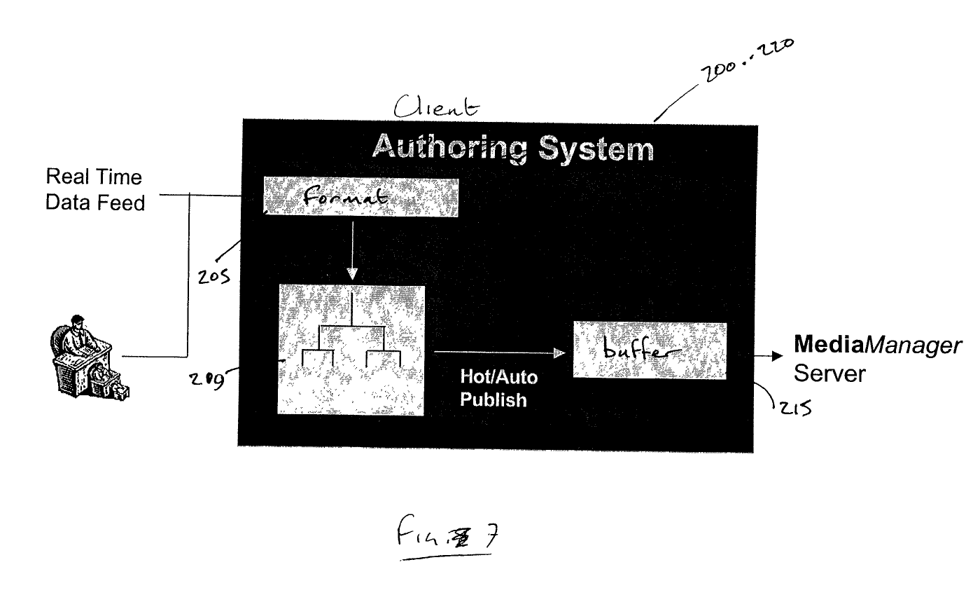

data defining the manner of broadcast, such as data carousel descriptors (see FIG. 6 below)

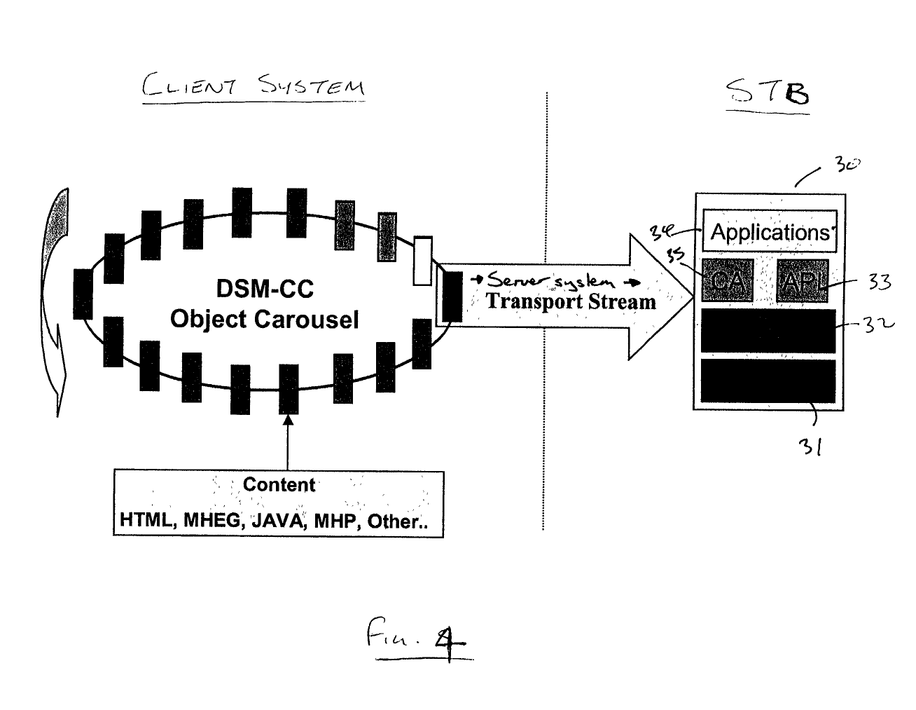

scheduling data defining the temporal nature of the broadcast (see FIG. 5 below)

These items are received by the server system 240 via the data connection 230. The user verification data is checked to identify the user, to verify its authority to broadcast programme content via that server, and to establish whether any access permissions have been issued to that client system. The data content is stored by the RAID array 246 under the control of the storage servers 242, 244. The carousel descriptors and scheduling data are stored by the storage servers.

At the appropriate time defined by the scheduling data supplied from the client system, as long as that time lies within the range defined by a previously issued access permission for that client, the data content is read from the RAID array 246 and, under control of the storage servers 242, 244, passed to the DSM-CC carousel servers 250, 260 to be formatted into the broadcast format defined by the carousel descriptors and the like received from the client system. The storage servers also ensure that data is not supplied for broadcast at a data rate higher than that permitted under the relevant access permission.

FIG. 4 is a schematic diagram illustrating a DSM-CC carousel comprising a rotating set of data items output in turn to be multiplexed into the DVB stream for broadcast. Each data item could be, for example, a HTML object, an MHEG object, a Java object, an MHP object or the like. At the STB 30, these data objects can either be run as programs by processing hardware 31 under the control of an operating system 32 and an application programming interface 33, or provide source data to be viewed or otherwise acted upon by applications 34 resident within the STB. As noted, the STB also handles conditional access relating to the received content.

DVB-MHP is only one example, albeit a very important one, of an STB environment which is relevant to the broadcast systems described here.

FIG. 5 schematically illustrates an example of a service delivery timeline. This is a temporal representation of programme content to be broadcast and is set up at the client system. It is transmitted as scheduling information by the client system to the server system.

The timeline may be displayed as part of a graphical user interface and defines time along a horizontal axis, with bit-rate along a vertical axis. In the present example, each vertical division signifies a bit rate of 50 kilobits/second.

The time axis is marked with tow times, “start” and “end” which are the limits of the time period allocated to that client by the relevant access permission. As described above, the client may initiate content for broadcast during that time period.

The example access permission defines three periods within the overall permission period:

from “start” to “t1”, a bit rate of 50 kb/s may be used

from “t1” to “t2”, a bit rate of 200 kb/s may be used

from “t2” to “end”, a bit rate of 100 kb/s may be used

Accordingly, the operator has selected three data content items for broadcast during these respective periods, namely content A, content B and content C. When the content is downloaded from the client system to the server system, all three content items are sent with respective identifiers, along with scheduling data defining the following scheduling information:

from “start” to “t1”, broadcast content A at 50 kb/s

from “t1” to “t2”, broadcast content B at 200 kb/s

from “t2” to “end”, broadcast content C at 100 kb/s

The server system ascertains whether this scheduling data is within the limits defined by the access permission (it is) and broadcasts the relevant content in accordance with these instructions. Because the data is broadcast in a carousel fashion, a higher bit rate simply means that the carousel proceeds around faster.

In other words, the scheduling task has moved away from the broadcaster (as in FIG. 1) to the content provider.

FIG. 6 schematically illustrates a service delivery planning tool. This is used to define the carousel arrangement (if one is used) and the way in which data is to be handled by the STB. The planning tool of FIG. 6 may form part of a graphical user interface at the client system.

In a left-most column are reference names for each data item forming part of the content to be broadcast. These reference names are mapped (in a second column) to filenames of data which—at the time of the planning operation—are stored at the client system, but which will later be transferred to the server system if they are included within the content to be broadcast.

A third column defines a playout operation for each item. Loop symbols, such as those at Page 4 and Page 6 of FIG. 6, indicate a carousel operation whereby the indicated data items are played out one after another in circular fashion. Other entries in the third column can indicate whether that item is to form part of the current programming.

FIG. 7 schematically illustrates the arrangement of FIG. 1 operating in a live service feed mode. In this mode, a real-time or quasi-real-time data feed (such as a news event or a commentary from Parliamentary debate or the like) is supplied to a data formatter 205 which operates to insert the data feed into the appropriate position in the data structure 109 described above with reference to FIG. 6. Changes to the data structure are passed to a buffer 215 and from there to the server system 240 (with an identifier to specify its position in the data structure) to amend the corresponding content data hierarchy held on the RAID array. When each data item comes round for broadcast in accordance with the carousel descriptors held by the storage servers at the server system 240, the most recent update received for that data item is supplied for output to the DSM-CC carousel servers.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

I claim:

1. A digital broadcasting arrangement comprising:
(i) one or more content-originating client systems by which digital content for broadcast is originated; and
(ii) a broadcast server system operable to receive digital content from said client systems and to broadcast that digital content for reception by end-users;
in which:
(i) said server system is operable to assign to each client system an access permission defining at least a time period and a digital data bandwidth available within that time period; and
(ii) each client system is operable to define digital content for broadcast during said time period defined by said access permission assigned to that client system and scheduling control data defining said manner in which the digital content is to be broadcast during that time period.

2. A broadcasting arrangement according to claim 1, in which said digital content comprises data representing a broadcast data service.

3. A broadcasting arrangement according to claim 2, in which said data service conforms to said DVB-Multimedia Home Platform data format.

4. A broadcasting arrangement according to claim 1, in which said digital content is arranged for repetitive broadcast as a carousel arrangement over said time period defined by said access permission.

5. A broadcasting arrangement according to claim 1, in which each client system is operable to transfer said scheduling data to said server, said server scheduling said content for broadcast in accordance with said transferred scheduling data.

6. A broadcasting arrangement according to claim 1, in which said server system is linked to at least one of said client systems by a remote data connection.

7. A broadcasting arrangement according to claim 1, in which said server system and at least one client system are operated by different companies.

8. A client system for interacting with a broadcast server system in a digital broadcast arrangement,
(i) said client system being operable to originate digital content for broadcast; and
(ii) said client system being operable to define digital content for broadcast during said time period defined by an access permission assigned to that client system by said broadcast server and scheduling control data defining said manner in which said digital content is to be broadcast during that time period.

9. A broadcast server system for interacting with one or more content-originating client systems in a digital broadcasting arrangement,
(i) said broadcast server system being operable to receive digital content from said client systems and to broadcast that digital content for reception by end-users; and
(ii) said broadcast server system being operable to assign to each client system an access permission defining at least a time period and a digital data bandwidth available within that time period.

10. Computer software which, when executed on data processing apparatus, causes said data processing apparatus to function as a client system according to claim 8

11. Computer software which, when executed on data processing apparatus, causes said data processing apparatus to function as a server system according to claim 9.

12. A storage medium by which software according to claim 10 is stored.

13. A storage medium by which software according to claim 11 is stored.
